(19) United States
(12) Patent Application Publication
(10) Pub. No.: US 2010/0230087 A1
(43) Pub. Date: Sep. 16, 2010

(54) Cooling using micro-plasma excited on transmission lines structure

(76) Inventor: Chien Ouyang, Sunnyvale, CA (US)

Correspondence Address: Chien Ouyang, 6335 Paseo Santa Cruz, Pleasanton, CA, 94566, US

(21) Appl. No.: 12/290,346

(22) Filed: Oct. 30, 2008

Related U.S. Application Data
(60) Provisional application No. 61/001,088, filed on Oct. 31, 2007.

(51) Int. Cl. G05D 23/00; F28F 13/12; F28F 7/00

(52) U.S. Cl. 165/287; 165/109.1; 165/185

(57) ABSTRACT

One embodiment of the present invention uses transmission lines structure to excite micro-plasma. The excited micro-plasma will induce a gas flow to cool down heat sink assembly. The micro-plasma may be excited with a DC source, a RF source, or a microwave source. In one embodiment, the transmission lines structure may comprise a microstrip conductor, a stripline conductor, a conductor trace, a paired differential traces, a dielectric layer, a ground layer, a dielectric resonator, and a cavity. The transmission lines structure may have patterns to induce high electric field at local regions. The micro-plasma may be used to create local turbulence near solid surface to enhance the heat transfer efficiency.

### BACKGROUND OF THE INVENTION

1. Field of the Invention

The present invention relates generally to electronic equipment, and more particularly, to apparatus and methods for cooling electronic devices using micro-plasma or ions excited by transmission lines structure.

2. Description of the Related Art

Electronic devices may generate significant heat during operation. High temperatures may reduce the lifespan of these devices, and, therefore, the generated heat may need to be dispersed to keep the operating temperature of the electronic devices within acceptable limits.

One commonly used cooling device is heat sink. Heat sinks may be coupled to electronic devices to absorb heat through the heat sink base and disperse the heat through their fins. Conventional methods to disperse the heat through the heat sink fins are natural convection and forced convection. Natural convection is to disperse the heat away from the surfaces of heat sink fins without the aid of external forced fluid pumping through heat sink fins. On the other hand, the forced convection cooling is to pump the fluid to flow through heat sink fins, such as the fans to blow the air through the heat sink fins, and therefore enhance the heat transfer between fins and outside ambient.

With the increasing power density of electronic devices, the pitch or the distance between heat sink fins is becoming smaller, which means more surface area may be used to transport the heat away. However, when the pitch becomes very small, the pressure drop between inlet and outlet of the heat sink fins may become very high, which may results the difficulties to pump the fluid flowing through fins, and as a result, more powerful fans, which consume higher electricity power may be needed for the cooling. The invention utilizes micro-plasma to induce the gas flow to conduct the convective heat transfer along the heat sink fins and therefore will resolve these issues.

Another consideration of the electronic device cooling is that, due to size concern, the internal space allowed to put cooling fans and other cooling components, may be limited or not permitted. The invention utilizes the transmission lines structure to excite micro-plasma and then to generate the forced convective heat transfer. Therefore the design is able to improve the heat transfer efficiency and to minimize the required space because excited micro-plasma can be very small.

Another aspect of using the invention is to lower the required power of the system fans of electronic devices. The micro-plasma driven gas flow, or ion-driven gas flow, excited by the transmission lines structure may couple with the heat sink fins to induce convective flow. A movement of the fluid flow along the heat sink fins will help carry the heat away from heat sink fins surface so the cooling will be better achieved. Therefore the system fan doesn't need to be very powerful in order to cool down heat source. From the viewpoint of the fluid dynamics, the viscous effect on the sold surface is one of the most important factors affecting the heat transfer efficiency. By using the transmission lines structure to excite the micro-plasma will create a local turbulent flow near the solid surface and hence the fluid momentum is increased. The increment of the momentum or turbulent flow near solid surface will improve the cooling efficiency.

Plasma-driven gas flow has been used either to cool articles or to control and modify the fluid dynamics boundary layer on the wings surfaces of the aerodynamic vehicles. For example, U.S. Pat. No. 3,938,345 used the phenomenon of corona discharge, which is one type of plasma, to do the local cooling of an article. U.S. Pat. No. 4,210,847 designed an apparatus for generating an air jet for cooling application. U.S. Pat. No. 5,554,344 had a gas ionization device to do the cooling of zone producing chamber. U.S. Pat. No. 6,796,532 B2 used a plasma discharge to manipulate the boundary layer and the angular locations of its separation points in cross flow planes to control the symmetry or asymmetry of the vortex pattern.

However, none of the above patents are coupled to the heat sink, which is a fundamental apparatus for cooling electronic devices. Hence, what are needed are a method and an apparatus, to couple with heat sink fins to cool down electronic devices efficiently.

### SUMMARY OF THE INVENTION

The embodiment of the present invention provides a cooling apparatus and method, which use the coupling of micro-plasma with the heat sink fins to cool down the heat sources. The micro-plasma is excited by transmission lines structure on a substrate.

In one embodiment, the micro-plasma may be excited with DC source, RF source, and microwave electromagnetic wave source.

In one embodiment, the transmission lines structure may comprise a microstrip conductor, a stripline conductor, a conductor line, a dielectric layer, and a ground layer.

In one embodiment, the transmission lines may have patterns in order to induce high electric field at local regions, and the distance between transmission lines may be varied.

In one embodiment, the dielectric material which is coupled with transmission lines may have patterns, and the dielectric material will protect the transmission lines structure from wear or corrosion when operated under high local electrical field.

In one embodiment, the dielectric resonator may couple with transmission lines structure to excite micro-plasma.

In one embodiment, the volume enclosed by heat sink fins and transmission lines structure may act as a cavity so the electromagnetic wave may be applied to transmission lines structure at the cavity's resonant frequencies.

In one embodiment, the substrate where the transmission lines structure is displaced may contain micro-cavities to excite micro-plasma, and the electric voltages applied to the transmission lines structure may be at cavity's resonant frequencies to increase the response.

In one embodiment, a pair of conductor lines may be applied with differential signals and the differential signals will greatly reduce the electromagnetic interference.

In one embodiment, the micro-plasma may be used to create local turbulence and disturbance in the fluid near solid surface to enhance the heat transfer efficiency.

In one embodiment, the sharp electrodes may couple to heat sink base, heat sink fins, and transmission lines structure to enhance the micro-plasma excitation.

In one embodiment, the two electrical voltages or waveforms applied to the differential paired conductor traces may be different.

In one embodiment, the voltage applied to the first trace may have magnitude and phase difference from the voltage applied to the second trace.

In one embodiment, the pair of parallel conductive traces may be manufactured on a printed circuit board and the printed circuit board may be made of rigid or flexible material.

In one embodiment, the pair of parallel conductive traces may be made with different scale, such as, a bulk scale, a micron-meter scale, or a nano-meter scale.

### BRIEF DESCRIPTION OF THE DRAWINGS

A better understanding of the present invention may be obtained when the following detailed description is considered in conjunction with the following drawings, in which:

FIG. 1a illustrates a cooling device using micro-plasma generated on a transmission lines structure;

FIG. 1b illustrates a side view of the heat sink fins assembly;

FIG. 1c illustrates a cooling device using micro-plasma generated on a pair of differential signal transmission lines;

FIG. 2a-2f illustrates a pair of differential transmission lines structure;

FIG. 3a illustrates a pair of differential signal transmission lines on a substrate;

FIGS. 3b and 3c illustrate dielectric material couple to a pair of differential signal transmission lines;

FIG. 3d illustrates the transmission line is embedded inside dielectric material;

FIG. 4a-4e illustrate the transmission lines structure coupled to a heat sink assembly to cool down heat source;

FIG. 5a-5c illustrate the micro-plasma induced gas flow;

FIG. 6a-6b illustrate the micro-plasma is excited with a transmission line structure;

FIG. 6c illustrates a cavity structure is used to excite a micro-plasma;

FIG. 7a-7c illustrate the micro-plasma is excited with a transmission lines structure on a substrate;

FIG. 7d-7e illustrate the micro-plasma is excited with a transmission lines structure coupled with a cavity structure on the heat sink assembly;

FIG. 8a-8c illustrate sharp electrode couple to heat sink base;

FIG. 8d-8e illustrate sharp electrode may couple to heat sink fin, heat sink base, and transmission lines structure.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims. Furthermore, note that the word “may” is used throughout this application in a permissive sense (i.e., having the potential to, being able to), not a mandatory sense (i.e., must). The term “include”, and derivations thereof, mean “including, but not limited to”. The term “coupled” means “directly or indirectly connected”.

### DETAILED DESCRIPTION OF THE INVENTION

The invention generally relates to apparatus for cooling electronic devices or packages, such as microprocessors, and ASIC. Such systems and methods may be used in a variety of applications. A non-exhaustive list of such applications includes the cooling of: a microprocessor chip, a graphics processor chip, an ASIC chip, a video processor chip, a DSP chip, a memory chip, a hard disk drive, a graphic card, a portable testing electronics, a personal computer system.

Take laptop computer for example, conventional fans use a lot of space and energy. For this reason, the micro-plasma cooling represents a way to increase their cooling capacity and make them more reliable and far quieter. Therefore the higher-performance chips that generate too much heat for current laptops can be used.

As used herein “plasma” is an ionized gas, a gas into which sufficient energy is provided to free electrons from atoms or molecules and to allow both species, ions and electrons, to coexist. Plasma is even common here on earth. A plasma is a gas that has been energized to the point that some of the electrons break free from, but travel with, their nucleus. Gases can become plasmas in several ways, but all include pumping the gas with energy. A spark in a gas will create a plasma. A hot gas passing through a big spark will turn the gas stream into a plasma that can be useful. Plasma torches like that are used in industry to cut metals.

As used herein “dielectric” is a substance that is a poor conductor of electricity, but an efficient supporter of electrostatic fields. In practice, most dielectric materials are solid. An important property of a dielectric is its ability to support an electrostatic field while dissipating minimal energy in the form of heat. The lower the dielectric loss (the proportion of energy lost as heat), the more effective is a dielectric material. Another consideration is the dielectric constant, the extent to which a substance concentrates the electrostatic lines of flux. Substances with a low dielectric constant include a perfect vacuum, dry air, and most pure, dry gases such as helium and nitrogen. Materials with moderate dielectric constants include ceramics, distilled water, paper, mica, polyethylene, and glass. Metal oxides, in general, have high dielectric constants.

As used herein “transmission line” is the material medium or structure that forms all or part of a path from one place to another for directing the transmission of energy, such as electromagnetic waves or acoustic waves, as well as electric power transmission. Components of transmission lines include wires, coaxial cables, dielectric, slabs, optical fibers, electric power lines, and waveguides.

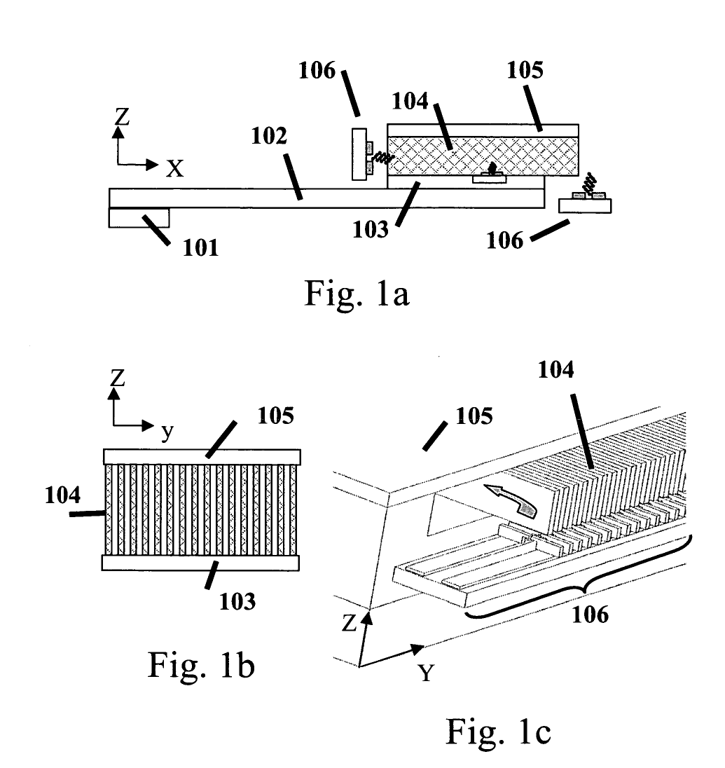

FIG. 1 illustrates a configuration of cooling device using micro-plasma actuator 106 excited by a transmission lines structure. The heat source 101 generates heat and the heat is transferred to heat sink fins 104 through a media 102, such as, heat pipes, water-cooling pipes, copper conductive pipes, carbon nano-tube pipes, and other pipes made of high thermal conductivity materials. The micro-plasma, excited by transmission lines structure, will couple with heat sink fins assembly to induce a flow to cool down the fins. The micro-plasma actuator 106 may be located at inlet, at the outlet, or in the middle of the heat sink assembly. The heat sink fins 104 may be assembled on a heat sink base 103 and may be covered by a cover 105. FIG. 1b illustrates the side view of a typical heat sink fins assembly. However, other configurations of the heat sink fins may be implemented to utilize the micro-plasma induced flow, such as pin heat sink fins. FIG. 1c illustrates one example of using transmission lines structure to excite the micro-plasma. In this example, the micro-plasma actuator 106 is composed of a pair of transmission lines. In the following, the voltages applied to the paired transmission lines will be referred as differential signals, and the pair of lines will be referred as differential pair, differential transmission lines, or paired differential transmission traces.

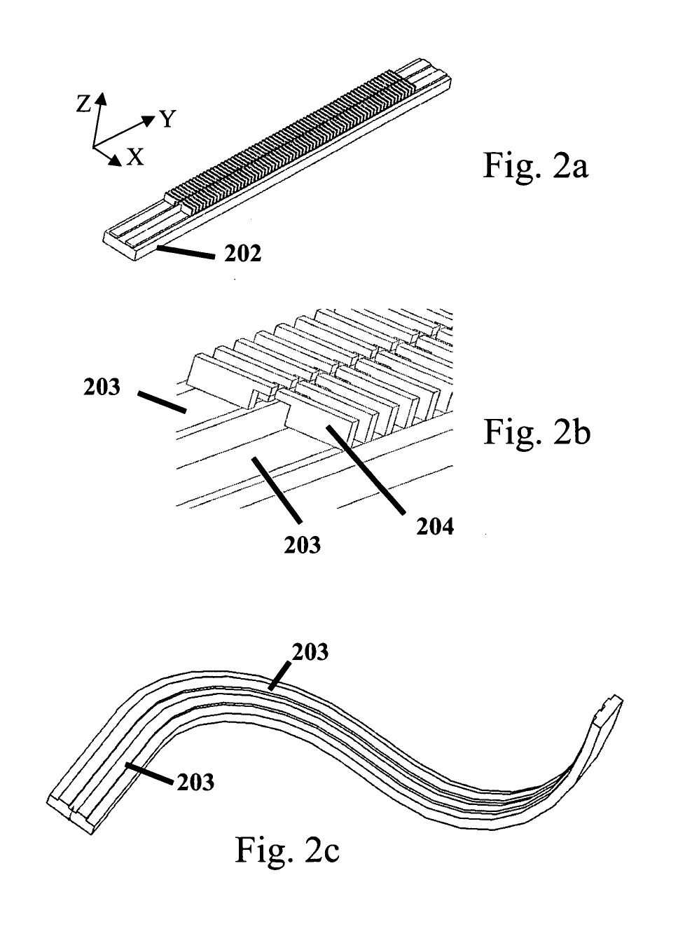

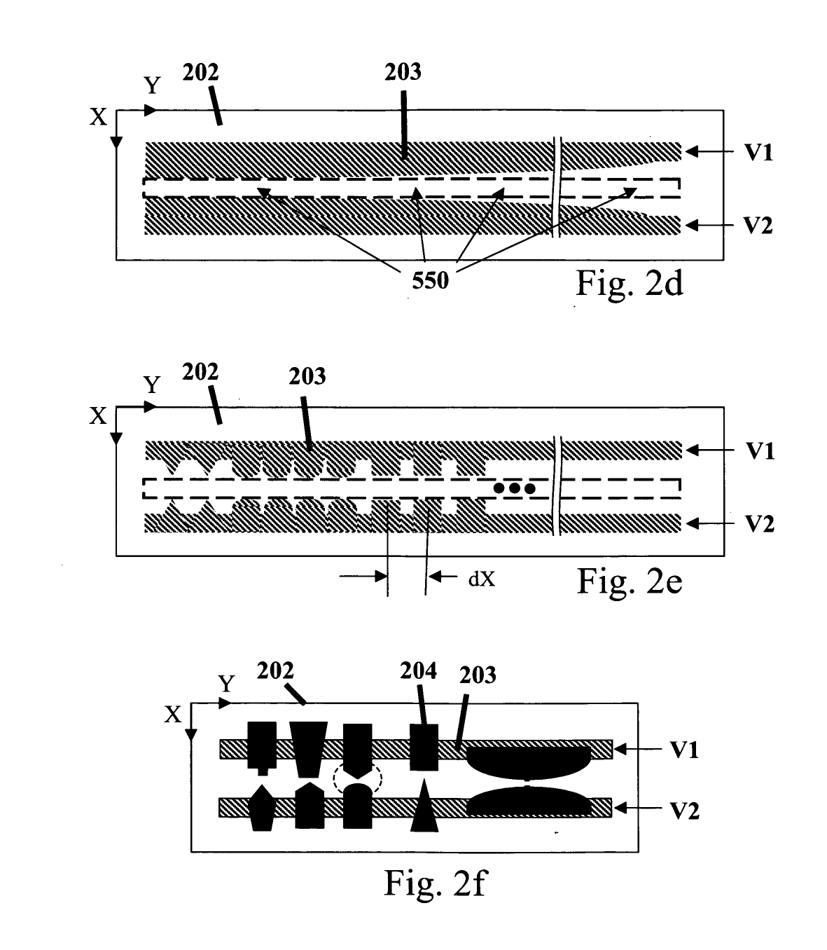

FIG. 2a illustrates two conductor lines 203 are on a substrate 202 and the ground 201 is at the bottom. FIG. 2b illustrates that the high permittivity dielectric material 204 may couple to the conductor lines. FIG. 2c illustrates that the pair conductor line 203 may be in arbitrary configurations, such as curved geometry. FIG. 2d illustrates that the width of the conductor lines and the gap distance between conductor traces may be varied and FIG. 2e illustrates that the conductor traces may have patterns as well. FIG. 2f illustrates a top view of the device showing that the dielectric material 204 may be configured to have patterns. For example, in order to obtain desired local electric field distributions in the gap region, the patterns of conductive traces 203 and dielectric material 204 will help increase the electric field at the tip of the patterns. For the differential signaling, one signal V1 is applied to one conductor and another signal V2 is applied to the other conductor as shown in the figure. The advantage of using differential signaling for the micro-plasma excitation is explained below.

In the electronics industry, and particularly in portable and mobile devices, there is a continuing tendency to lower the supply voltage in order to save power and reduce unwanted emitted radiation. A low supply voltage, however, causes problems with signaling because it reduces the noise immunity. Differential signaling helps to reduce these problems because, for a given supply voltage, it gives twice the noise immunity of a single-ended system

To see why, consider a single-ended digital system with supply voltage Vₛ. The high logic level is Vₛ and the low logic level is 0 V. The difference between the two levels is therefore Vₛ−0V=Vₛ. Now consider a differential system with the same supply voltage. The voltage difference in the high state, where one wire is at Vₛ and the other at 0 V, is Vₛ−0V=Vₛ. The voltage difference in the low state, where the voltages on the wires are exchanged, is 0V−Vₛ=−Vₛ. The difference between high and low logic levels is therefore Vₛ−(−Vₛ)=2Vₛ. This is twice the difference of the single-ended system. The result is that it takes twice as much noise to cause an error with the differential system as with the single-ended system. In other words, the noise immunity is doubled.

Different from the application of low voltage as for portable or mobile electronic devices, the invention here is to use micro-plasma or ions to drive the gas flow to cool down electronic devices, and therefore the applied voltages at local spots such as the gap region between patterns must be high enough to create ions. The required electrical field is dependent on the dimension of the electrodes in the transmission lines structure. However, when a high electrical field is applied on the transmission lines structure, the electrical charge may damage the nearby electronic devices and the unbalanced charge potential may cause a problem in practical applications. For example, if only one positive charged voltage is applied to the transmission lines structure, the ground plane or nearby devices may be electrically charged to be positive as well and the charged potential may damage the nearby IC devices. By using differential pair, the positive charge from one conductor line may balance out the negative charge from the other conductor line. In other words, the local charged potentials near the transmission lines structure are still there, but the global charged potentials are balanced. The local charged potentials, which can be positive or negative, are to create ions flow at local regions. The ions or micro-plasma driven gas flow will therefore induce a gas flow to cool down the electronic devices. The balanced of the two charged potential, or defined as global charged potentials, will guarantee the safety of nearby electronic devices. In one embodiment, the micro-plasma excited by the paired differential transmission lines may greatly lower the electromagnetic interference, EMI, because differential signals radiate less than single-ended signals do. That's one of the benefits of differential logic. If the two complementary signals of a differential pair are perfectly balanced, the separation between traces entirely determines the degree of field cancellation.

This advantage is not actually due to differential signaling itself, but to the common practice of transmitting differential signals on balanced lines. A balanced line reduces the noise on a connection by rejecting common-mode interference. Its two wires are routed in parallel so that they receive the same interference. They also have the same impedance to ground, so the interfering fields or currents induce the same voltage in both wires. Since the receiver responds only to the difference between the wires, then the signal received by the receiver will not be influenced by the noise. Manufacturers can further reduce noise by twisting the two wires of a pair together, as in Cat-3 Ethernet cables or in telephone wires, so that any noise induced in one half-twist tends to cancel the noise induced in the neighboring half-twist. Where a pair becomes unbalanced, for example due to insulation failure, noise will be induced.

The differential voltages may have different waveforms. For example, a voltage, V1=sin(2*pi*f*t), may be applied to one conductor line, and a voltage, V2=−sin (2*pi*f*t), may be applied to another conductor line, where f is the frequency, t is time. In one embodiment, the voltage may have an offset, for example, V1=C+sin (2*pi*f*t) and V2=−C−sin (2*pi*f*t), where C is a constant voltage. Then the two voltages can balance out each other. In one embodiment, the frequency, amplitude, phase, and direction of the applied signals to the paired conductor lines may be varied. In one embodiment, the impulse, irregular, and transient voltages may be applied to paired conductor lines. The typical operation of the differential signaling is with even mode, which means, for example, one conductor is running from 0 to 1 volt, but the other conductor line is running from 0 to −1 volt. In another embodiment, we may apply non-even-mode voltages or transient voltages to the paired conductor lines to generate the micro-plasma. One potential application is to generate the fluctuating micro-plasma. A disturbance of the applied voltage will cause the disturbance of the micro-plasma and the disturbance may help increase the turbulence in the gas flow. In one embodiment, the magnitude, frequency, waveform, and time period of the applied voltages may be used to control the speed, direction, and momentum of the micro-plasma gas flow.

The micro-plasma excited with a pair of transmission lines structure is used for cooling in the invention. But it can be adapted for other applications, such as, RF or microwave irradiation heating, drying, dehydration, curing, disinfection, pasteurization, sterilization, vaporization or ionization or any combination. The process and apparatus provide for a controlled processing of planar or non-planar material, a combination of materials organic or inorganic, and a combination of materials of solid or liquid or gas. In one embodiment, the invention can be used for the fields of medical, veterinary, food and environmental diagnostics. In another embodiment, the invention can be used in the field of plasma physics, which requires controlled high-energy RF or microwave sources. One application of the invention for medical application is to provide an apparatus for propagating controlled RF or microwave energy into heart tissues to produce a desired temperature profile therein at tissues depths sufficient for thermally ablating arrhythmogenic cardiac tissues, organs, and blood. The uniqueness of the invention is to provide a controlled RF or microwave power within a specific region.

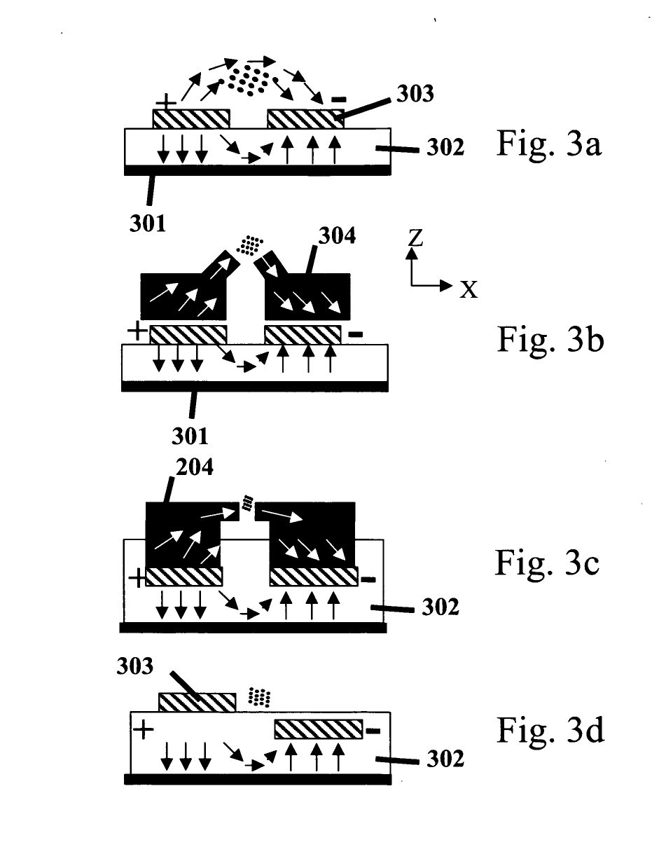

One important factor to generate micro-plasma is to have high electric field. Differential signals transmission lines provide a method to generate local high electric field. FIG. 3a to FIG. 3d illustrate cross sectional view of possible configurations of the dielectric materials 304 coupled to conductor lines 303, substrate 302, and ground 301. The arrows are the electric field lines. The conductor traces 303 may be embedded inside dielectric layer 304 and may be exposed to ambient atmosphere. The micro-plasma, represented by the dots in the figure, may be generated at local locations and the micro-plasma may couple to heat sink fins to induce the gas flow to do the cooling. In one embodiment, the positive ions generated from one end of the conductor line and the negative ions generated from the other end of the conductor line may couple together to enhance the ion-drive flow. For example, one conductor trace is applied with positive voltage to induce positive ions to flow away from its trace, while a negative voltage is applied to the other conductor to induce the negative ions to flow way from its conductor traces, and therefore, the summed gas flow direction is from first conductor trace to second conductor trace. In one embodiment, the second conductor trace may be electrically grounded then the system becomes single source excitation, or the second conductor trace is applied with a lower voltage then the system still has two sources excitation. In one embodiment, the gap distance between the conductor lines may need to be carefully designed to maximize the flow speed.

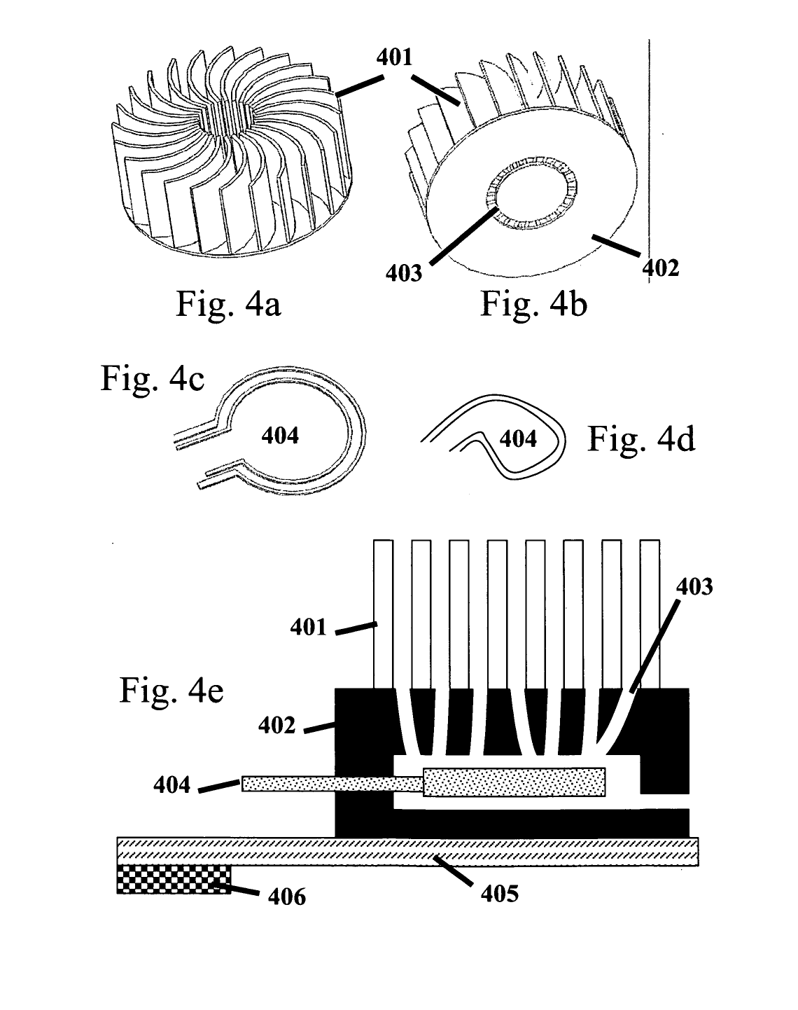

FIG. 4a-4e illustrates another example of using micro-plasma to cool down the heat sink assembly. FIG. 4a shows the top view of a heat sink assembly, which has curved shape heat sink fins 401. The bottom side of the heat sink base 402 is shown in FIG. 4b. The micro-plasma induced gas flowing through the circular opening passage 403 is used to do the cooling. In one embodiment, the heat sink fins may be straight or curved, or other configurations. The circular paired transmission lines structure 404, as shown in FIG. 4c, is couple to the heat sink base 402 and opening passage 403 to cool down the heat sink assembly. The paired transmission lines structure 404 may have varied configurations and the FIG. 4d illustrates two paired wires are coupled together. FIG. 4e illustrates one cooling mechanism. The heat source 406 generates heat, the heat is conducted to heat sink assembly through a heat conducting pipe 405, such as heat pipe, the heat conducting pipe is coupled to heat sink base 402, the transmission lines structure 404 is coupled with heat sink base 402 and opening passages 403, the micro-plasma induced gas flow through the opening passage 403, and therefore the heat is carried away to ambient through the convection of the heat sink fins 401 surfaces. In one embodiment, the transmission lines structure coupled to heat sink base does not necessary to be paired, a single conductor trace will still be able to excite the micro-plasma, but the electromagnetic interference will be much larger. In another embodiment, the opening passage 403 may be in any configurations, such as, a straight-line slot, a circular-ring slot, a round hole, a square hole, etc. Furthermore, the substrate where transmission lines structure is displaced may have varied configurations in order to couple with heat sink base.

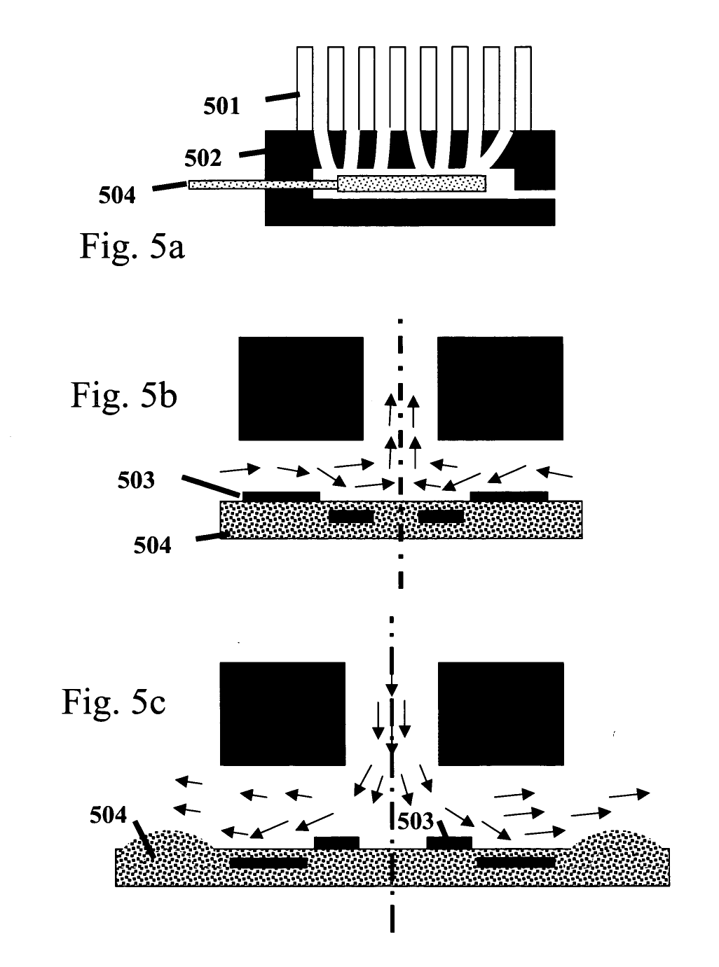

FIG. 5a illustrates a cooling configuration. The plasma-induced gas flows through the opening passages to the heat sink fins. The heat is dissipated to ambient through the convection of the heat sink fin surface. FIG. 5b illustrates a cross sectional view of the micro-plasma actuator coupled to a heat sink base 502. One conductor trace 503 is exposed to air and one conductor trace is embedded inside the dielectric material 504. The conductor traces 503 may be in a circular configuration, such as shown in FIG. 4c, to induce an impinging jet. The mechanism is as shown in FIG. 5b. By varying the conductor traces configuration, the micro-plasma induced gas flow direction may be reversed as shown in FIG. 5c.

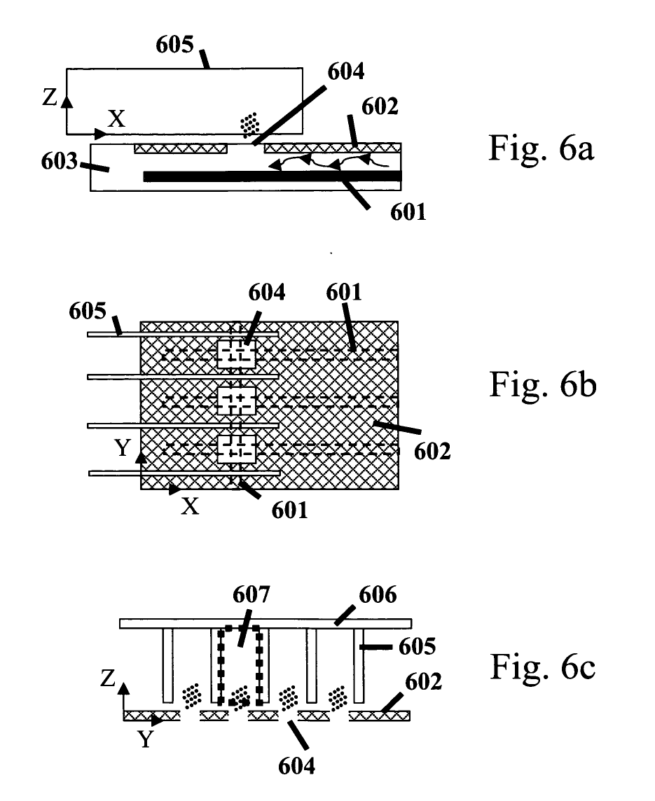

Besides the paired differential transmission lines excitation, there are several ways to excite micro-plasma. FIG. 6a illustrates a stripline 601 embedded inside the substrate 603 and the there are openings 604 on the conductor plane 602. The electromagnetic energy may leak, through openings 604 to outside, and couple with heat sink fins 605. The micro-plasma may be designed to generate at specific locations, for example, at the location of dots as shown in the figure to induce the gas flow to do the cooling. FIG. 6b illustrates the top view of the configuration. In one embodiment, the striplines and openings may have different shapes and geometries. The openings may be not square and the striplines may not be straight lines. The striplines and openings may couple with each other with different configurations and with different directions.

FIG. 6c illustrates another cross sectional view of the heat sink fins 605, with heat sink cover 606 on top, and openings 604. In one embodiment, the volume 607 enclosed by heat sink fins 605, heat sink cover 606, and conductor plane 602, may act as half-open microwave cavity. When the cavity is excited at specific frequencies, such as resonant frequencies, the characteristic electric and magnetic field may be utilized to generate micro-plasma. In another embodiment, the heat sink fins may have different configurations and geometries to couple with striplines and openings, and all these variation shall be considered within the scope of the embodiment here.

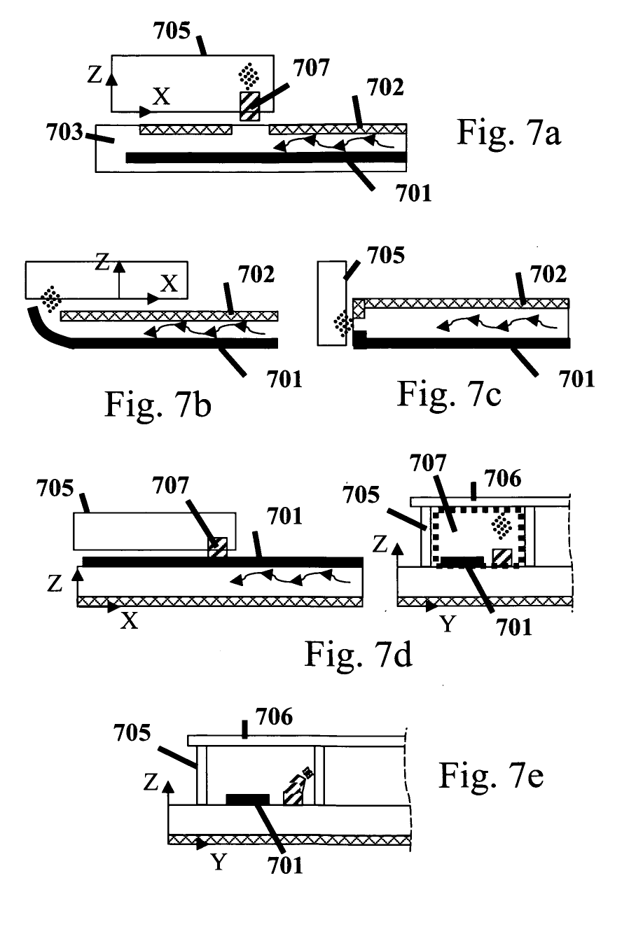

FIG. 7a to FIG. 7c illustrate some configurations of using transmission lines structure to excite micro-plasma. In one embodiment, dielectric resonator 707 may couple to the transmission lines structure to excite micro-plasma. The dielectric resonator 707 may have different shapes and geometries and its location relative to transmission line components and heat sink fins are important. To optimize the electromagnetic coupling among dielectric resonator, transmission lines structure, and heat sink fins, the computer simulation is commonly used. FIG. 7d illustrates another example of a dielectric resonator 707 couple to a conductor line 701 and heat sink fins 705. In another embodiment, similar as FIG. 6c, the volume 707 as shown in FIG. 7d can act as a half open cavity, and the characteristic electric field at its resonant frequencies may be used to excite micro-plasma. In one embodiment, high frequency RF or microwave may be used when the dimension of the transmission lines structure become very small.

As the pitch of the heat sink fins become smaller, it will be more difficult for air to pass through due to the viscous effect on the heat sink fins surface. In one embodiment, the micro-plasma excited by the transmission lines structure will create local turbulence and therefore it helps the heat removal from the surface of heat sink fins. In another embodiment, the dielectric resonator may couple to transmission lines structure and heat sink fins to enhance the heat transfer. The high electrical field generated near the dielectric resonator is used to excite micro-plasma FIG. 7e illustrates one possible configuration to create micro-plasma near heat sink fins surface. Other configurations of using micro-plasma to create local turbulence near heat sink fins can be done similarly. However, the variation of the configurations shall be considered within the scope of the embodiment here.

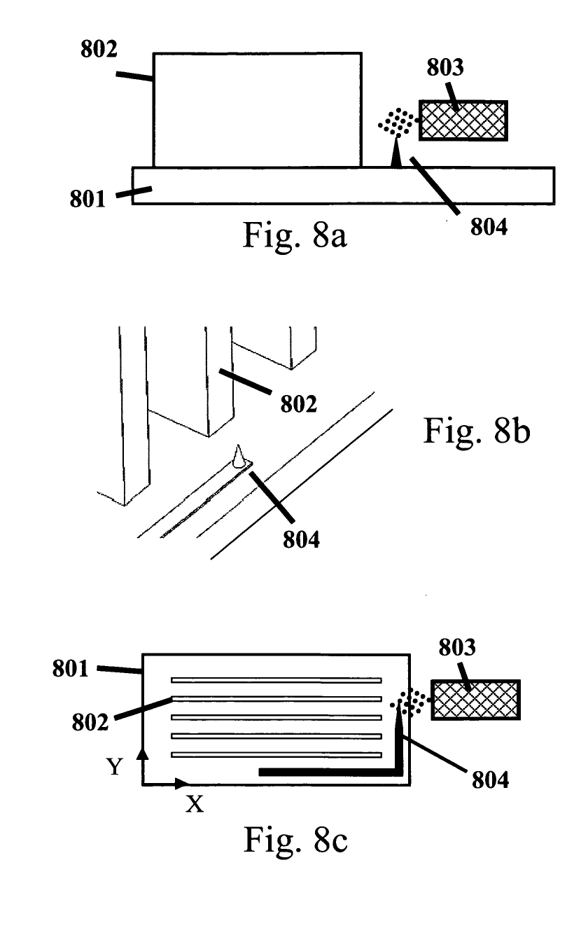

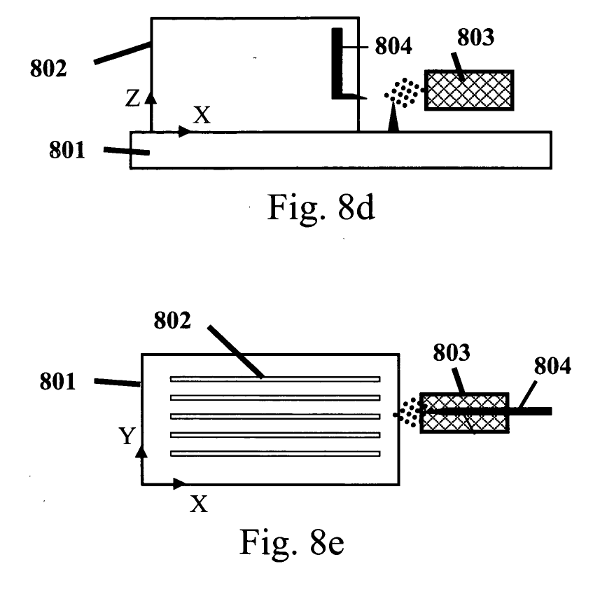

As mentioned earlier, micro-plasma may be used to create local turbulent flow. FIG. 8a to FIG. 8c illustrate that the sharp electrode 804 may couple to heat sink base 801 to enhance the micro-plasma excitation. The sharp electrodes 804 may be on a conductor trace or on a paired of conductor traces. The applied voltages on the conductor traces may be adjusted to control the momentum of the gas flow. In one embodiment, a feedback control system may be implemented. For example, a thermal sensor may be used to detect the temperature of the power source, a micro-controller or IC may be used to read the temperature and to control the magnitude, frequency, and timing of the applied voltages to the transmission lines structure. Therefore, the temperature of the heat sources may be controlled. Furthermore, FIG. 8d illustrates that the sharp electrode 804 may couple to heat sink fins 802 and heat sink base 801 to enhance the micro-plasma excitation. FIG. 8e illustrates that the sharp electrode 804 may couple to transmission lines structure 803 to enhance the micro-plasma excitation.

What is claimed is:

1. A method and apparatus for cooling electronic devices, comprising a micro-plasma actuator excited by transmission lines structure, and a heat sink assembly;

2. The cooling device of claim 1, wherein the transmission lines structure is coupled with a substrate and a dielectric layer;

3. The cooling device of claim 1, wherein the transmission lines structure is composed of a conductor trace;

4. The cooling device of claim 1, wherein the transmission lines structure is composed of a pair of a conductor traces; and one conductor trace is applied with a voltage and the other conductor trace is applied with another voltage;

5. The cooling device of claim 1, wherein the transmission lines structure is composed of conductor lines and dielectric material, and the conductor lines and dielectric material may have patterns;

6. The cooling device of claim 1, wherein the transmission lines structure is to excite micro-plasma and the micro-plasma is to induce the disturbance, turbulence, and momentum in the gas flow;

7. The cooling device of claim 1, wherein the paired transmission lines structure is composed with a circular configuration to induce an impinging jet flow;

8. The cooling device of claim 1, wherein the transmission lines structure is displaced on a substrate, wherein the said substrate have openings, cavities, and dielectric resonator, to excite micro-plasma;

9. The cooling device of claim 1, wherein the transmission line structure is to be applied with DC, RF, and microwave sources to excite micro-plasma; and the said sources may comprise impulse, steady, and transient waveforms;

10. The cooling device of claim 1, wherein the transmission lines structure comprising a microstrip conductor, a stripline conductor, a conductor line, a dielectric layer, a dielectric resonator, and a ground layer;

11. The cooling device of claim 1, the transmission lines structure is manufactured in a bulk scale, in a micron-meter scale, and in a nano-meter scale;

12. The cooling device of claim 1, the transmission lines structure is made of a printed circuit board and the said printed circuit board may rigid or flexible material;

13. The cooling device of claim 1, wherein the heat sink assembly comprising sharp electrodes displaced on the heat sink base and heat sink fins;

14. The cooling device of claim 1, wherein the heat sink assembly comprising a cavity structure to couple with transmission lines structure to excite micro-plasma;

15. The cooling device of claim 1, wherein the micro-plasma actuator is coupled with a feedback microprocessor controller to control the temperature of the heat sources.
